(19) United States
(12) Patent Application Publication
(10) Pub. No.: US 2026/0064170 A1
(43) Pub. Date: Mar. 5, 2026

(54) METHOD TO OPTIMIZE INPUT VOLTAGE FOR LOWER POWER DISSIPATION AND TIGHT TOLERANCE IN PASSTHROUGH ARCHITECTURE

(71) Applicant: DELL PRODUCTS L.P., Round Rock, TX (US)

(72) Inventors: Wei-Cheng Yu, New Taipei City (TW); Merle Jackson Wood, III, Round Rock, TX (US); Chi-Che Wu, Taipei (TW); Chin-Jui Liu, Luzhu District (TW)

(21) Appl. No.: 18/821,682

(22) Filed: Aug. 30, 2024

(51) Int. Cl. G06F 1/18; G06F 1/26; G06F 1/28

(52) U.S. Cl. CPC G06F 1/189; G06F 1/266; G06F 1/28

(57) ABSTRACT

A device for receiving power from a power supply and providing power to an information handling system including an embedded controller configured to monitor a load condition for the power supplied to the information handling system and regulate an output voltage of a power supply to maintain the output voltage supplied to the information handling system within a tolerance.

### FIELD OF THE DISCLOSURE

The present disclosure generally relates to a method to optimize input voltage for lower power dissipation and tight tolerance in passthrough architecture.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A device for receiving power from a power supply and providing power to an information handling system. The device may include an embedded controller configured to monitor a load condition for the power supplied to the information handling system and regulate an output voltage of a power supply to maintain the output voltage supplied to the information handling system within a tolerance.

A method can include monitoring, by an embedded controller, a load condition and a DC resistance for a voltage supplied to an information handling system; calculating, by the embedded controller, a required voltage required from a power supply to maintain the voltage supplied within a tolerance; and adjusting the power supply voltage to the calculated required voltage.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of a system illustrating input voltage optimization in a passthrough architecture according to at least one embodiment of the present disclosure;

FIG. 2 is a flow diagram of a method for optimizing input voltage for lower power dissipation and tight tolerance in passthrough architecture according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

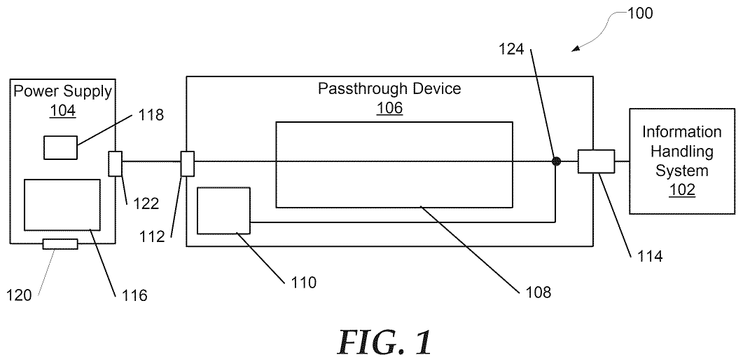

FIG. 1 illustrates a system 100 for providing power to an information handling system 102. System 100 includes a power supply 104 and a passthrough device 106, such as a dock. The passthrough device 106 includes a power board 108, an embedded controller 110, a DC input 112, and a USB Type C connector 114. The power supply 104 includes a variable voltage rectifier 116, a power delivery controller 118 for selecting the output voltage, an AC input 120, and a DC outlet 122.

Power supply 104 can receive an alternating current (AC) via AC input 120. The variable voltage rectifier 116 can convert the AC into DC which is provided to the DC outlet 122. The variable voltage rectifier 116 can produce a DC output at multiple voltages, and the power delivery controller 118 can control which voltage the variable voltage rectifier 116 provides.

Passthrough device 106 can receive the DC output from power supply 104 at the DC input 112. The DC voltage can be provided to the power board 108 which can pass the DC voltage to the USB Type C connector 114. Embedded controller 110 can monitor the input voltage from the power supply 104. The USB Type C connector 114 can provide power to the information handling system 102.

The embedded controller 110 continuously checks the input voltage, such as at contact 124, in real-time to ensure that it meet the required voltage level for proper operation of the information handling system 102. In various embodiments, the embedded controller 110 can average multiple voltage measurements, such as 3 or 4 measurements each taken 1 second apart. If the embedded controller 110 detects that the input voltage is insufficient, indicating a potential drop in voltage along the power path and DC cable, it initiates corrective action to adjust the output voltage of the power adapter. In various embodiments, the tolerance can be about +/−5%. The adjustment can compensate for the voltage drop and ensure that the information handling system 102 receives a stable and adequate voltage supply. To facilitate the voltage adjustment, the embedded controller 110 communicates with the power delivery controller 118 to dynamically control the output voltage of the power supply 104. By communicating with the power delivery controller 118, the embedded controller 110 can instruct the power delivery controller 118 to either increase or decrease the output voltage based on the real-time monitoring of the input voltage.

Using an embedded controller to dynamically regulate the output voltage of the power supply and compensate for DC resistance of the current path reduces power dissipation by reducing the need for voltage regulation circuitry.

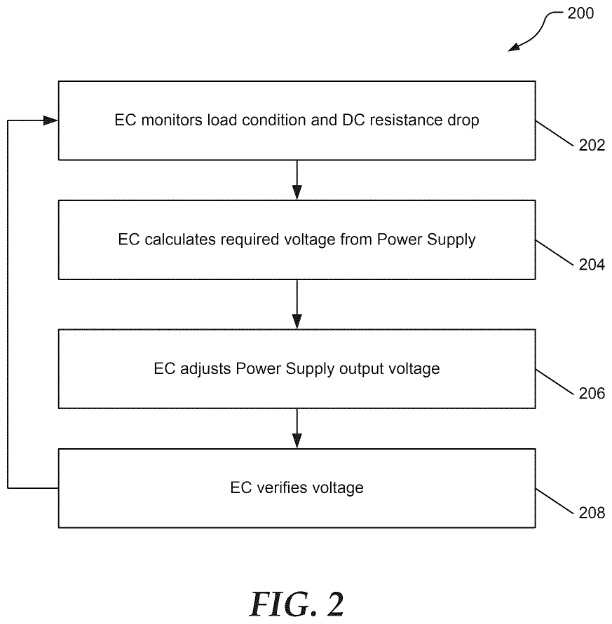

FIG. 2 is a flow diagram of method 200 for optimizing input voltage for lower power dissipation and tight tolerance in passthrough architecture. In low load situations, the resistance losses through the passthrough and USB cable are small. As the load increases, the resistance losses increase and can potentially cause the voltage supplied to the information handling system to drop below the tolerance required by the USB Type-C specification. On the other hand, if sufficient voltage for a high load situation is supplied during a low load situation, the voltage supplied may be above the tolerance required by the USB Type-C specification due to the small resistance losses.

At step 202, an embedded controller, such as embedded controller 110, monitors the load condition and the DC resistance of the passthrough and the USB cable. In various embodiments, the embedded controller 110 may average multiple readings, such as three or four readings at one second intervals, of the voltage going to the USB Type-C connector.

At step 204, the embedded controller calculates the required output voltage of the power supply to maintain compliance with the USB Type-C power delivery specifications. In various embodiments, the embedded controller can maintain the voltage to the USB Type-C connector to within a tolerance of +/−5%.

In various embodiments, the information handling supply can request one of several fixed voltage options, such as 28 V, 36 V, or 48 V. The requested voltage from the power supply can be the fixed voltage plus a voltage offset. The voltage offset can be equivalent to the power draw of the passthrough device and DC resistance losses due to the cabling. For example, the voltage offset can be 0.5 V to 0.7 V. Additionally, the requested voltage from the power supply can be incremented in 0.1 V increments as needed to compensate for changes to the DC resistance losses.

In various embodiments, the information handling system may send an adjustable voltage supply request. An adjustable voltage supply request can request a voltage between 15 V up to a maximum voltage in 100 mV increments. In response, the embedded controller can calculate the needed voltage from the power supply as the highest voltage supplied by the power supply that is not greater than 5 A times the voltage requested in the adjustable voltage supply request. Additionally, the voltage requested from the power supply can be adjusted in 0.1 V increments as needed to compensate for changes to the DC resistance losses.

At 206, the embedded controller communicates with the power delivery controller of the power supply to adjust the power supply output voltage. The power delivery controller can select the requested voltage to be supplied based on the request from the embedded controller.

At 208, the embedded controller verifies the voltage supplied by the power supply is within tolerance. Returning to 202, the embedded controller can continue to monitor the load condition and ensure the voltage supplied to the information handling system is within tolerance.

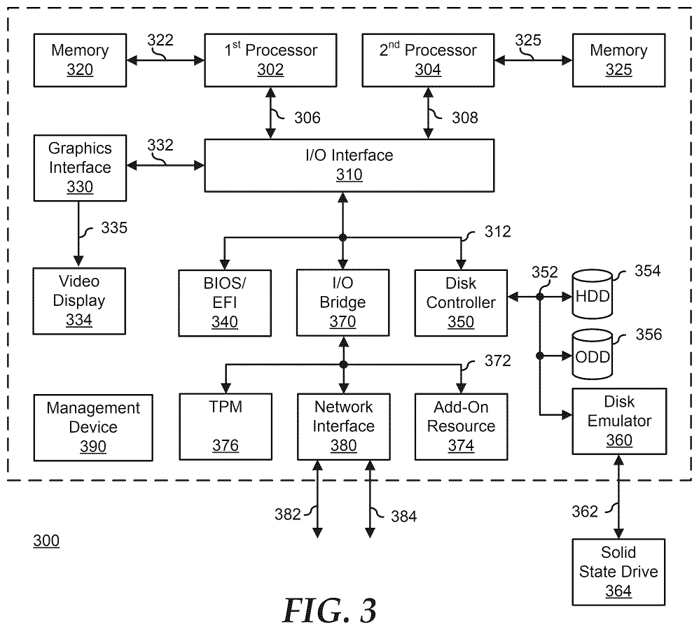

FIG. 3 shows a generalized embodiment of an information handling system 300 according to an embodiment of the present disclosure. Information handling system 300 may be substantially similar to information handling system 102 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 3394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A device to receive power from a power supply and provide power to an information handling system comprising:
a power board to pass the power from the power supply to the information handling system; and
an embedded controller configured to monitor a load condition for the power supplied to the information handling system and regulate an output voltage of the power supply to maintain the output voltage supplied to the information handling system within a tolerance.

2. The device of claim 1, wherein the device is connected to the information handling system via a USB Type-C connection.

3. The device of claim 1, wherein the tolerance is +/−5%.

4. The device of claim 1, wherein the embedded controller to communicate with a power delivery controller to select the voltage output by the power supply.

5. The device of claim 1, wherein the embedded controller monitors the load condition based on the voltage supplied to the information handling system.

6. The device of claim 5, wherein embedded controller is configured to average a plurality of voltage readings.

7. The device of claim 1, wherein embedded controller is configured to receive an adjustable voltage supply request from the information handling system; and calculate a voltage needed from the power supply to satisfy the AVS request.

8. A method comprising:
monitoring, by an embedded controller, a load condition and a DC resistance for a voltage supplied to an information handling system;
calculating, by the embedded controller, a required voltage required from a power supply to maintain the voltage supplied within a tolerance; and
adjust the power supply voltage to the calculated required voltage.

9. The method of claim 8, wherein the voltage is supplied to the information handling system via a USB type-C connection.

10. The method of claim 8, wherein the tolerance is +/−5%.

11. The method of claim 8, wherein adjusting the power supply voltage includes communicating with a power delivery controller to select the voltage output by the power supply.

12. The method of claim 8, wherein monitoring the load condition and the DC resistance includes reading the voltage supplied to the information handling system.

13. The method of claim 12, wherein monitoring the load condition and the DC resistance further includes averaging a plurality of voltage readings.

14. The method of claim 8, further comprising receiving an adjustable voltage supply request from the information handling system; and wherein calculating the required voltage includes calculating a voltage from the power supply that is not greater than 5 amps times adjustable voltage supply request.

15. An information handling system comprising:
a power supply;
a computing device; and
a passthrough device to receive power from power from the power supply and provide power to the computing device; the passthrough device including an embedded controller configured to monitor the output voltage of the power supplied to the computing device and adjust the voltage supplied by the power supply to maintain the output voltage supplied to the computing device within a tolerance.

16. The information handling system of claim 15, wherein the power supplied to the computing device is via a USB type-C connection.

17. The information handling system of claim 15, wherein the tolerance is +/−5%.

18. The information handling system of claim 15, wherein the embedded controller communicates with a power delivery controller to select the voltage output by the power supply.

19. The information handling system of claim 15, wherein the embedded controller monitors the load condition based on the voltage supplied to the information handling system.

20. The information handling system of claim 19, wherein embedded controller can average a plurality of voltage readings.
